(19) United States
(12) Patent Application Publication
(10) Pub. No.: US 2013/0063736 A1
(43) Pub. Date: Mar. 14, 2013

(54) INFORMATION PROCESSING APPARATUS, METHOD, AND PROGRAM

(71) Applicant: Kazumi Chiba, Kawasaki-shi (JP)

(72) Inventor: Kazumi Chiba, Kawasaki-shi (JP)

(73) Assignee: CANON KABUSHIKI KAISHA, Tokyo (JP)

(21) Appl. No.: 13/583,164

(22) PCT Filed: Jun. 22, 2012
(86) PCT No.: PCT/JP2012/004071

§ 371 Date: Sep. 6, 2012

(30) Foreign Application Priority Data
Jun. 30, 2011 (JP) 2011-145385

(51) Int. Cl. G06K 15/02

(52) U.S. Cl. 358/1.6

(57) ABSTRACT

An information processing apparatus comprises a softmask setting means for setting a softmask every combination of objects of an overlap portion of the objects and a softmask applying means for applying the softmask to the overlap portion of the objects in accordance with the setting performed by the softmask setting means.

### TECHNICAL FIELD

The invention relates to a creation of a document constructed by objects such as text, image, and the like and, more particularly, to a setting of a softmask.

### BACKGROUND ART

A Print On Demand (hereinbelow, referred to as “POD”) is a digital print technique maximally using a digital image forming apparatus such as digital copying apparatus, digital multifunction apparatus, or the like. As a merit of the POD, such merits that it is advantageous for printing of a small lot and a short delivery date and a Variable Data Print (hereinbelow, referred to as “VDP”) in which a printing that is customized every customer is realized can be performed can be mentioned. A print system for realizing the VDP is generally called a VDP system. Print data in the VDP system is generally called VDP data. A document serving as a source for forming the VDP data is called a VDP document.

In the VDP data which is used in the VDP, it is divided into a fixed portion and a variable portion and the data in the variable portion is supplied from database data such as RDB (Relational Database), CSV (Comma Separated Values) file, or the like.

Hereinbelow, the database data is referred to as “DB data”. The variable portion is called “variable region” and the fixed portion is called “fixed region” hereinbelow. The DB data has various kinds of information such as character string information like a name, sex, an address, and the like of the customer, numerical value information like an age and the like, and the like.

The VDP document is formed by a VDP application having an editing function of the VDP document. The VDP application has a user interface for designating positions and a layout of the variable region and the fixed region. The VDP application also has a user interface for designating conditions and the like for deciding an object to be printed into each variable region on the basis of information of the DB data. The object is an object constructing a print document such as text, image, or the like and a type of attribute of the object such as text, image, or the like is hereinbelow called an object type. It is assumed that the image includes graphics. The object has, for example, information regarding a size such as width and height, information regarding a color of the object, and the like.

Further, the VDP application has a function for forming the VDP data on the basis of a designated item. Many of the VDP data is described by using a structured PDL (Structured Page Description Language) for the VDP. The structured PDL is a PDL in which a document structure of the PDL is expressed by using a markup language. The structured PDL is a PDL in which a document structure of the PDL is described by a markup language based on, for example, XML (Extensible Markup Language). PPML (Personalized Print Markup Language) is one of VDP language formats for efficiently performing the VDP printing. The PPML has a layer structure based on the XML format. The PPML is output as a print job from the VDP application. A print job of the VDP described by the PPML is hereinbelow called “PPML data”.

Generally, in the VDP application, the positions and layout of the variable region and the fixed region are designated by an arrangement of frames by the user. When the frames are arranged, the object type such as text, image, or the like is also designated together with them. At this time, all sizes of the objects in the variable region which are customized every customer are not always the same size. Therefore, when the object is actually arranged in the variable region and drawn, such a problem may occur that a part of the object or the whole object in the variable region overlaps with a neighborhood object and an overlap portion of the object in the variable region and the neighborhood object becomes difficult to view. Even in the case where there is an object such as a background which is arranged so as to overlap with the frame from the beginning, such a problem may occur that when the object is arranged in the variable region and drawn, the variable region becomes difficult to view. An object which is drawn first is called “background” and an object which is drawn later is called “foreground” hereinbelow.

As for a problem about an appearance of the overlap portion, a phenomenon differs in dependence on a combination of the object types, transparency which the object has, and the presence or absence of a background color of the frame. For example, when a combination of the object types of the overlap portion is that the background is a text and the foreground is an image, if the image is perfectly opaque, the text cannot be perfectly seen, and if the image has transparency, the text is transparent. When the background is an image and the foreground is a text, if the frame of the text has a background color, the image cannot be perfectly seen, and if the frame does not have a background color, the image other than the portion where it overlaps with the text can be perfectly seen. However, at this time, there is a possibility that the text is difficult to view in dependence on a concentration or the like of the image. When both of the background and the foreground are texts, if the frame of the foreground text has a background color, the background text cannot be perfectly seen. On the other hand, if it does not have a background color, the background text other than the portion where it overlaps with the foreground text can be perfectly seen. However, at this time, there is a possibility that the background text and the foreground text overlap with each other and are difficult to view. When both of the background and the foreground are images, if the foreground image has transparency, the background image is transparent, and if the foreground image is perfectly opaque, the background image is absolutely invisible. The presence or absence of the transparency and the presence or absence of the background color of the frame are called “transparency information” hereinbelow.

As a related art, as disclosed in PTL1, such a technique that a link for preventing an overlap is preliminarily set to frames so that the frames which are arranged on a document template do not overlap exists. Sizes of the linked frames are adjusted in accordance with an image or text which is fed into a variable region so that the linked frames do not overlap with each other or they are adjusted so that the image or text lies within the frame.

### CITATION LIST

### Patent Literature

PTL 1: Japanese Patent Application Laid-Open No. 2006-244276

### SUMMARY OF INVENTION

### Technical Problem

However, if the size of frame is changed so that the neighborhood frame does not overlap as disclosed in the related art, the layout changes and there is a possibility that a finish state which the user desired is not obtained. Also in the case where the size of text or image is converted to the size at which the text or image lies within the frame, the original text or image is changed and such a problem that the image becomes too small that it becomes invisible or characters are broken and cannot be read occurs. In the case where the variable region is arranged on the background, since an overlap due to the linking of the frames cannot be avoided, the problem to the difficulty of seeing cannot be solved.

As mentioned above, according to the method of preventing the occurrence of the overlap portion due to the linking between the frames in the related art, since the layout or object size is changed without asking, there is a possibility that a finish which the user does not desire is obtained.

It is an object of the invention to set a softmask to a portion where objects overlap with each other in order to allow the user to provide an object of a desired appearance.

### Solution to Problem

In order to overcome the above problems, the invention provides an information processing apparatus comprising a softmask setting means for setting a softmask every combination of objects of an overlap portion of the objects and a softmask applying means for applying the softmask to the overlap portion of the objects in accordance with the setting performed by the softmask setting means.

### Advantageous Effects of Invention

According to the invention, it is possible to set the softmask for every combination of the overlapping manners of the objects and to form print job data in which the set softmask is applied to the relevant object.

Further features of the present invention will become apparent from the following description of exemplary embodiments with reference to the attached drawings.

### BRIEF DESCRIPTION OF DRAWINGS

FIG. 1 is a block diagram illustrating an example of a construction of a VDP system.

FIG. 2 is a block diagram illustrating an example of a construction of a client PC and a print server.

FIG. 3 is a diagram of an example of a block diagram illustrating a construction in which the VDP system operates.

FIG. 4 is a diagram for describing a module construction of a VDP application of an embodiment.

FIG. 5 is a diagram of an example for describing a softmask.

FIG. 6 is a table of an applying example of the softmask to a combination of overlapping manners of objects and its appearance state.

FIG. 7A is a diagram of an example for describing an application of a mask of a predetermined value and a gradation mask.

FIG. 7B is a diagram of an example for describing an application of a mask of a predetermined value and a gradation mask.

FIG. 7C is a diagram of an example for describing an application of a mask of a predetermined value and a gradation mask.

FIG. 8A is a diagram of an example of a template editing display screen.

FIG. 8B is a diagram of an example of a preview display screen.

FIG. 9A is a diagram of an example of a softmask setting display screen.

FIG. 9B is a diagram of an example in which after a selection of a frame is received, the softmask setting display screen is displayed.

FIG. 10 is a diagram of an example of softmask setting information.

FIG. 11 is a flowchart for describing a flow for softmask setting.

FIG. 12 is a flowchart for describing an application of a softmask to an overlap portion.

FIG. 13 is a flowchart for describing a flow for a softmask individual setting.

FIG. 14 is a diagram of an example in which a description of the softmask application is added to PPML data.

FIG. 15 is a softmask setting preview display screen for reading the PPML data and displaying a finish image of every record to the user.

FIG. 16 is a flowchart for describing a flow for a softmask application including an exchange of foreground and background objects.

FIG. 17A is a diagram of an example in which the gradation mask is applied to the selected frame.

FIG. 17B is a diagram of an example in which the gradation mask is applied to the selected frame.

FIG. 18 is a diagram of an example in which after a selection of one frame is received, the softmask setting display screen is displayed.

FIG. 19 is a flowchart for describing a flow for a softmask setting to the formed PPML data.

FIG. 20 is a flowchart for describing a flow from a creation of a VDP document to an output of VDP data.

FIG. 21 is a diagram of an example for describing an overlap state of objects which can be expressed by combination information of overlapping manners of objects.

### DESCRIPTION OF EMBODIMENTS

Embodiments of the invention will be described in detail hereinbelow on the basis of the drawings.

### First Embodiment

### <Fundamental Construction>

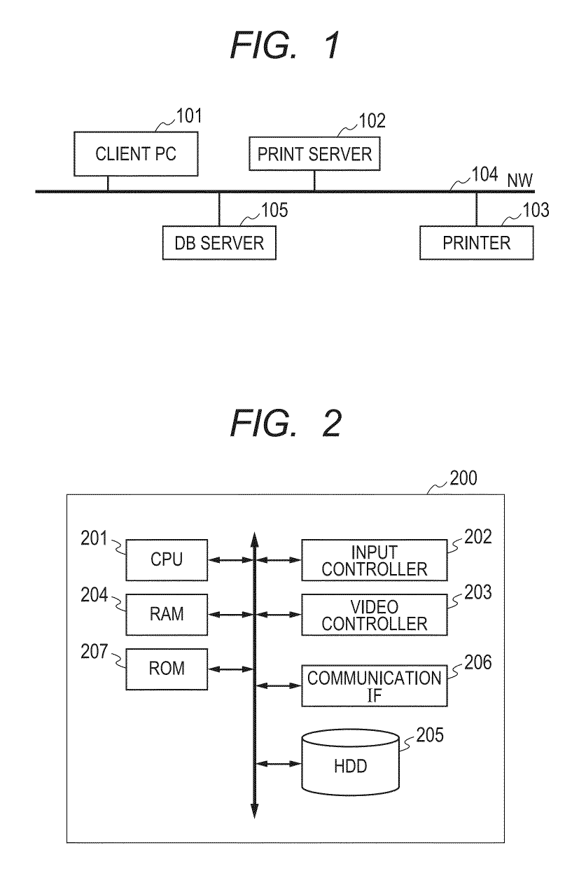

FIG. 1 is a block diagram illustrating an example of a construction of a Variable Data Print (hereinbelow, referred to as “VDP”) system having an information processing apparatus according to the embodiment. The Variable Data Print system has a client PC (personal computer) 101, a print server 102, a printer 103, and a DB (database) server 105. The printer 103, print server 102, and client PC 101 are connected through a network (hereinbelow, referred to as “NW”) 104 and can communicate with each other. The client PC 101 can transmit VDP data to the print server 102. The print server 102 can transmit a print instruction to the printer 103 via the NW 104. The printer 103 receives the print instruction via the NW 104. The DB server 105 stores DB data or the like which is used in a VDP application.

### <Construction of Computer Apparatus>

FIG. 2 is a block diagram illustrating an example of a construction of the client PC 101 and print server 102. In FIG. 2, a CPU 201 controls the whole apparatus in accordance with a control program stored in a RAM 204. A computer program which is executed by the CPU 201 has been stored in a ROM 207. The RAM 204 is a non-volatile memory and stores various kinds of programs and data files loaded from the ROM 207 or an HDD 205. The program stored in the RAM 204 reads out or writes contents of data which is stored in the RAM 204, receives an input from an input controller 202, or displays an image by a video controller 203. The CPU 201 loads the programs, data, and the like which are necessary upon execution of various kinds of processes into the RAM 204 and executes the programs, thereby realizing the various kinds of processes.

The input controller 202 controls an input from a pointing device such as keyboard, mouse, or the like. The video controller 203 controls a display to a display such as a CRT display (hereinbelow, referred to as “CRT”) or the like. The display is not limited to the CRT but may be a liquid crystal display or the like. The HDD 205 is a storage device of a large capacity. Various kinds of software which are executed by the CPU 201 have been stored in the HDD 205. The HDD 205 is also used as a temporary storage area of data which is processed. The various kinds of software stored in the HDD 205 are read out into the RAM 204 in accordance with necessity, functions of an operating system which has likewise been read out into the RAM 204 are used in accordance with necessity, and they are executed under control of the CPU 201.

A communication IF 206 is connected to and communicates with an external apparatus through the NW and executes a communication control process of a computer. For example, the communication IF 206 executes Internet communication using TCP/IP, a transmission and a reception of data to/from the printer, and the like. The CPU 201 executes, for example, a rasterizing process in an area for display information of the RAM 204, thereby enabling a display on the CRT to be performed. The CPU 201 also enables the user to instruct by a mouse cursor or the like on the CRT.

FIG. 3 is an example of a block diagram illustrating a construction in which the VDP system operates. Reference numeral 301 denotes a client PC and corresponds to the client PC 101 in FIG. 1. A VDP application 311 including an information processing apparatus for realizing the invention operates. A DB server 302 manages a DB 312. The DB 312 has DB data 315 for supplying data to a variable region of a variable data print document (hereinbelow, referred to as “VDP document”). In a printer 303, an RIP (Raster Image Process) program (hereinbelow, referred to as “RIP”) 313 operates and a printing process is executed by a printer engine 316. A print server 304 receives the PPML data from the client PC 301 and transmits to the printer 303 via the NW.

The VDP application 311 transmits an obtaining request for data designated as data in the variable region to the DB 312 of the DB server 302 through an NW 321 and obtains the DB data 315 through the NW 321. The VDP application 311 forms PPML (Personalized Print Markup Language) data 314 by using the obtained DB data 315. The VDP application 311 transmits the formed PPML data 314 to the print server 304 through an NW 322. Subsequently, the print server 304 which received the PPML data 314 transmits the PPML data 314 to the printer 303 together with a print instruction. The RIP 313 executes an RIP process to the PPML data 314, transmits a result of the RIP process to the printer engine 316, and executes a printing process.

### <Module Construction>

The embodiment will be described on the assumption that an information processing module of the invention has been installed as a part of the modules of the VDP application. However, the invention is not limited to it but may be an application independent of the VDP application.

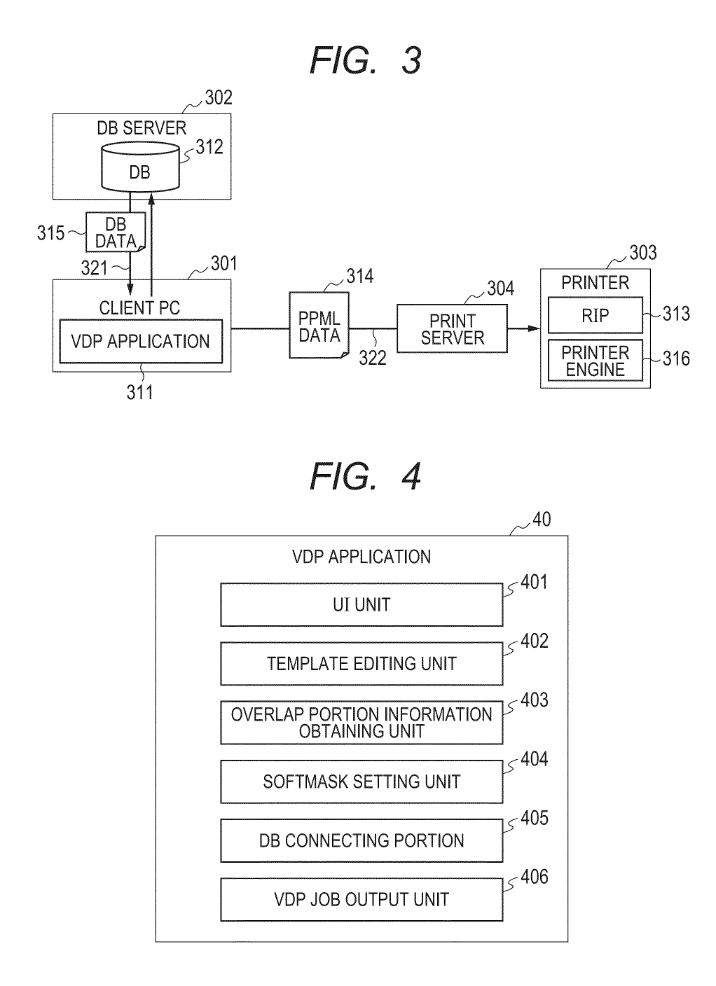

FIG. 4 is a diagram for describing a module construction of a VDP application 40 in the embodiment. The VDP application 40 is constructed by a UI unit 401, a template editing unit 402, an overlap portion information obtaining unit 403, a softmask setting unit 404, a DB connecting unit 405, and a VDP job output unit 406. The VDP application 40 operates on the client PC 301. An executing process of each module is controlled by the CPU 201.

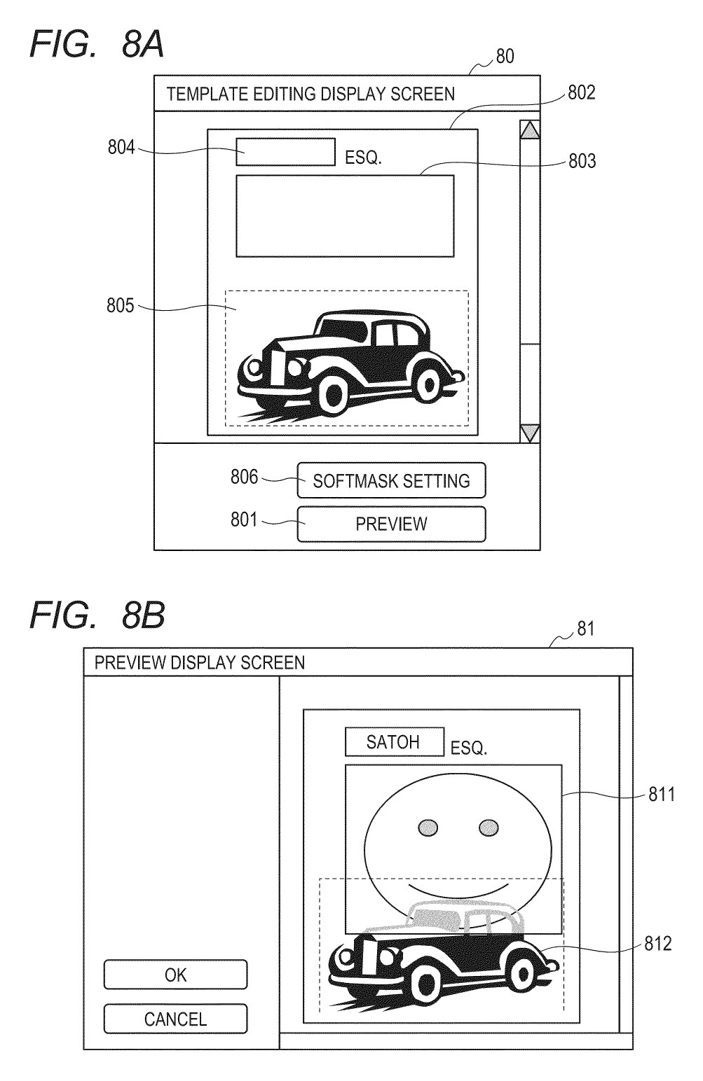

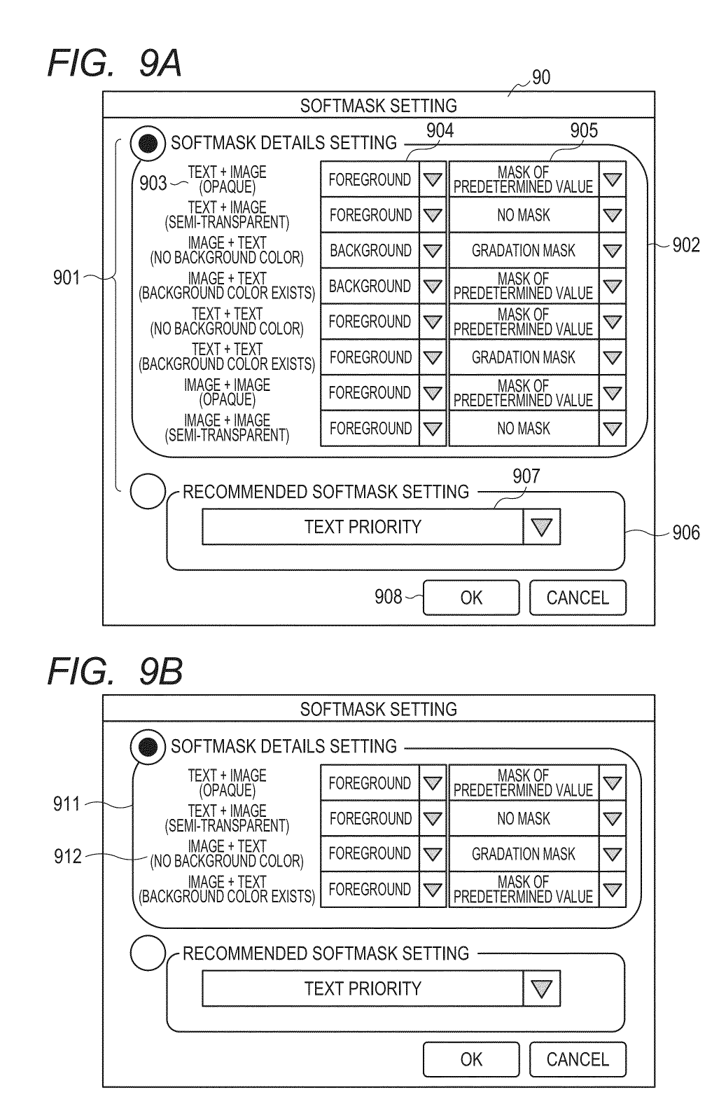

The UI unit 401 is a module for displaying a template editing display screen and a softmask setting display screen to the user and receiving the operation from the user. The template editing display screen will be described hereinafter by using FIGS. 8A and 8B. The softmask setting display screen will be described hereinafter by using FIGS. 9A and 9B.

The template editing unit 402 is a module for editing a template of the VDP document. In accordance with an editing instruction of the user received by the UI unit 401, an edition of a paper surface and a designation of a variable region/fixed region are reflected to the template. The DB data 315 obtained from the DB is applied to the variable region of the template. Since the template editing unit 402 is a function equipped for the general DP application 311, a detailed process is omitted.

The overlap portion information obtaining unit 403 is a module for obtaining information regarding a drawing region of an overlap portion and combination information of overlapping manners of objects. The information regarding the drawing region of the overlap portion denotes information regarding a drawing of print data such as shape, size, position, and the like of the overlap portion.

The combination information of the overlapping manners of the objects denotes a combination of an object type and transparency information of each object constructing the overlap portion. The information is expressed as follows by using the object types and transparency information of the background object and the foreground object. “Object type (the presence or absence of transparency) of the background object+object type (the presence or absence of transparency) of the foreground object”. An example of an overlap state of the objects which can be expressed by the combination information of the overlapping manners of the objects will be described by using FIG. 21. In FIG. 21, reference numeral 2101 denotes a foreground object; 2102 a background object; 2103 a portion constructing an overlap portion of the object 2101 with the object 2102; and 2104 a portion constructing an overlap portion of the object 2102 with the object 2101. Now, in the case of an image in which both of the object types of the objects 2101 and 2102 indicate a perfectly opaque image, the combination information of the overlapping manners of the objects is “image (opaque)+image (opaque)”. In the case of an image in which both of the object types of the objects 2101 and 2102 indicate a text of a frame having no background color and a perfectly opaque image, the combination information of the overlapping manners of the objects is “image (opaque)+text (no background color)”. For simplicity of description here, it is assumed that the presence or absence of transparency of the background object does not exert a large influence on a type of softmask which is set for the combination information of the overlapping manners of the objects. In the following description, a description about the presence or absence of transparency of the background object is omitted. In the case where the description about the presence or absence of transparency of the background object is omitted, the combination information of the overlapping manners of the objects is “object type of the background object+object type (presence or absence of transparency) of the foreground object”. The overlap portion information obtaining unit 403 will be described hereinafter.

The softmask setting unit 404 is a module for forming and editing softmask setting information in accordance with the editing instruction from the user received by the UI unit 401. The softmask setting information will be described hereinafter. The DB connecting unit 405 is a module for connecting to the DB 312 and obtaining the DB data 315. The VDP job output unit 406 is a module for outputting the VDP data in which the DB data 315 stored in the DB 312 and obtained by the DB connecting unit 405 has been applied to the variable region. The embodiment will be described on the assumption that a VDP job is the PPML data. A softmask is described in the VDP data in accordance with an instruction, which will be described hereinafter.

### <Softmask>

The softmask will be described. The softmask is defined as an object for making a part of the objects semi-transparent and is formed by using a bitmap. Since the transparency is set in accordance with a pixel value of the bitmap, a portion having a pixel value of the softmask applied to the object becomes semi-transparent and the background object becomes transparent. At this time, even if the bitmap which is defined as a softmask has an arbitrary color space, it can be formed. However, if the bitmap has a color space other than a gray scale, it is converted into the gray scale at the time of the RIP process.

Thus, the value changes by the RIP and there is a possibility that the softmask which the user desired is not obtained. Therefore, the embodiment will be described on the assumption that the softmask is formed by a bitmap of the gray scale.

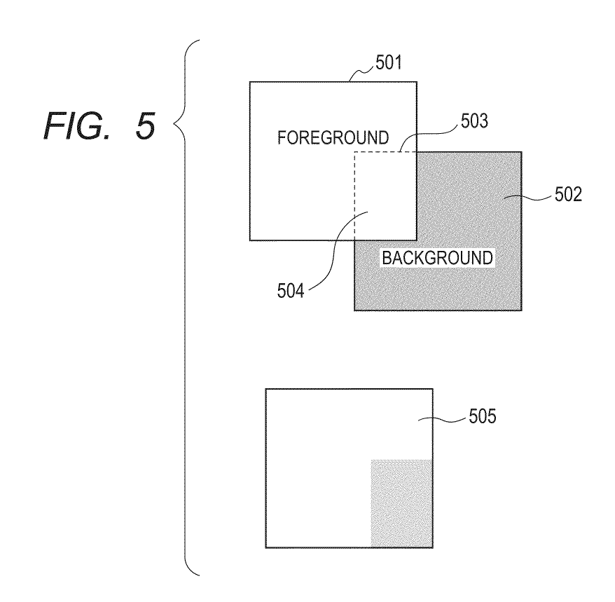

FIG. 5 is a diagram of an example for describing the softmask. In FIG. 5, reference numerals 501 and 502 denote perfectly opaque objects which do not have transparency and construct an overlap portion. Reference numeral 501 denotes the foreground object; 502 the background object; 503 an overlap portion of the object 501; and 504 an overlap portion of the object 502. Since the object 501 is drawn after the object 502, the overlap portion 504 is in a state where it is perfectly hidden by the overlap portion 503. An appearance such as “visible”, “invisible”, “transparent”, or the like is called “appearance state” hereinbelow. Reference numeral 505 denotes a softmask for partially making the object 501 semi-transparent so that the overlap portion 504 becomes transparent. The softmask 505 has the same size as that of the object 501 and is a bitmap of the gray scale in which only a portion of the overlap portion 503 of the object 501 has a pixel value. By the softmask 505, transparency is given only to the portion of the overlap portion 503 of the object 501, so that the overlap portion 504 becomes transparent. A state where the overlap portion becomes semi-transparent by the softmask is expressed as “softmask is applied” hereinbelow.

### <Appearance State and Softmask Application>

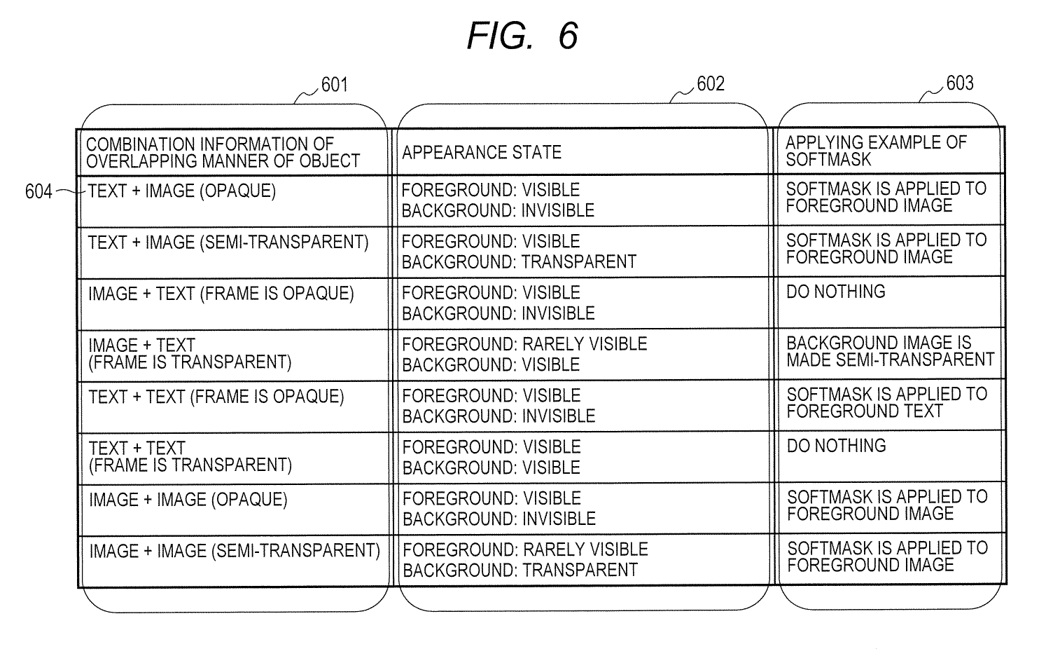

Since the appearance state of the overlap portion differs in dependence on the combination information of the overlapping manners of the objects, the combination information of the overlapping manners of the objects and the appearance state become materials for discriminating whether or not the softmask is applied. FIG. 6 is a table of an applying example of the softmask to the combination of the overlapping manners of the objects and the appearance state. In FIG. 6, reference numeral 601 denotes combination information of overlapping manners of objects; 602 an appearance state of the foreground and background objects of the overlap portion; and 603 an applying example of the softmask. For example, a line 604 denotes that an appearance state in the case where the combination information of the overlapping manners of the objects is “text+image (opaque)” shows that the foreground is visible and the background is invisible. At this time, if the user desires that the appearance state of the text is changed from “invisible” to “transparent”, by applying the softmask to the foreground image, the appearance of the background text which the user desires can be provided. This table is used as a material for discriminating the softmask selection at the time of a recommended softmask setting. The recommended softmask setting will be described hereinafter.

### <Type of Softmask>

The type of softmask will be described. In the embodiment, as a softmask type, the following three kinds are used: (1) a mask of a predetermined value, (2) a gradation mask, and (3) no mask. The mask of the predetermined value of (1) is a softmask in which an opaque degree is uniform in an applying region. The gradation mask of (2) is a softmask in which a density of the color is smoothly and continuously changed in the applying region so as to have a gradation in the designated direction such as “portrait”, “landscape”, “oblique”, or the like. The gradation mask is used, for example, in the case where a boundary between the applying region of the softmask and a region out of the applying region is made inconspicuous, the case where a portion which the user wants to improve the appearance state is distributed unevenly in the applying region, or the like. No mask of (3) denotes that the softmask is not applied to the overlap portion.

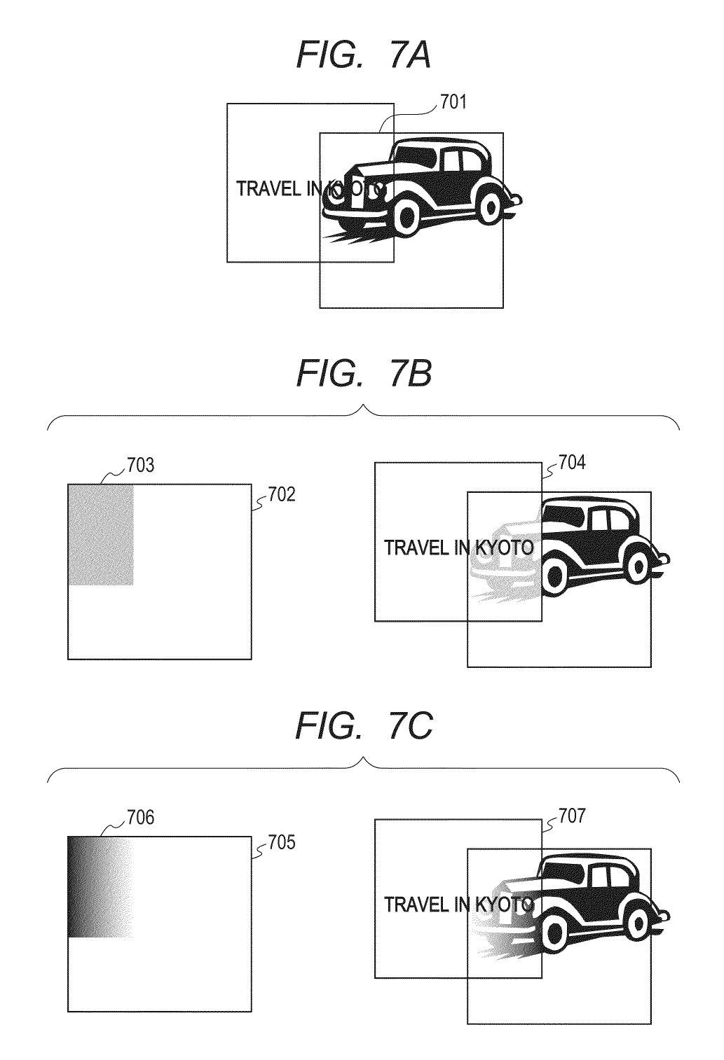

An application of the mask of the predetermined value and the gradation mask will be described by using FIGS. 7A and 7B. Reference numeral 701 in FIG. 7A denotes an overlap portion in which the combination information of the overlapping manners of the objects is “image+text (transparent)” and it has been set so that the softmask is applied to the overlap portion of the background object.

The application of the mask of the predetermined value to the overlap portion of the object in FIG. 7A will be described by using FIG. 7B. Reference numeral 702 denotes a mask of a predetermined value. The mask of the predetermined value 702 has the same size as that of the background object. A gray portion 703 having a pixel value has the same size as that of the overlap portion 701 in FIG. 7A. The mask of the predetermined value 702 is such a bitmap of the gray scale that only the overlap portion of the background object has a uniform pixel value. Since the transparency is set in accordance with the pixel value of the gray portion, if the softmask 702 is applied to foreground object in FIG. 7A, only the gray portion 703 of the softmask 702 becomes semi-transparent, so that the background object becomes transparent (704).

The application of the gradation mask to the overlap portion of the object in FIG. 7A will be described by using FIG. 7C. Reference numeral 705 denotes a gradation mask. The gradation mask 705 has the same size as that of the background object in FIG. 7A. A gray portion 706 having a pixel value has the same size as that of the overlap portion 701 in FIG. 7A. The gradation mask 705 is such a bitmap of the gray scale that the pixel value of the gray portion 706 is continuously changed in such a manner that the inside of a region of the overlap portion of the background object becomes a gradation. If the softmask 705 is applied to foreground object in FIG. 7A, the transparency changes smoothly in accordance with the pixel value of the gradation of the softmask 705, so that the background object becomes transparent (707).

### <Template Editing Display Screen>

FIG. 8A is a diagram of an example of a template editing display screen 80 of the VDP application. An editing instruction from the user which is executed on the template editing display screen 80 is processed by the template editing unit 402 in accordance with the editing instruction of the user received by the UI unit 401. Reference numeral 80 denotes a window for performing a layout of a VDP document; 802 a template to arrange objects into the VDP document; and 803 and 804 frames in each of which a variable region is arranged. An input signal of a keyboard or pointing device connected to the client PC 101 is received through the input controller 202 and the operation such as creation, movement, or selection is executed. Reference numeral 805 denotes a fixed region. Since an object which is drawn in the fixed region does not change in accordance with the information of the DB data 315, an object which is actually drawn is displayed. In FIGS. 8A and 8B, the objects which are arranged in the variable regions 803 and 804 on the basis of the DB data 315 are an image and a text, respectively. The variable region 804 is drawn precedently to the variable region 803. It is now assumed that the variable regions 803 and 804 can be expanded or contracted in dependence on sizes of the objects which are arranged on the basis of the designation of the DB data 315. Reference numeral 806 denotes a softmask setting button. When the UI unit 401 receives a selection of the softmask setting button 806, a softmask setting display screen is displayed. Reference numeral 801 denotes a preview button. When the UI unit 401 receives a selection of the preview button 801, a finish image of the printing to which the received softmask setting is applied is displayed on a preview display screen.

FIG. 8B is a diagram of an example of a preview display screen 81. Reference numeral 811 denotes a variable region and 812 indicates a fixed region. Both of the regions 811 and 812 are perfectly opaque images. The regions 811 and 812 have an overlap portion. The finish image of the printing in the case where the DB data 315 is applied to the variable region 811 and the softmask setting is applied to a print image as a result obtained by executing the RIP process is displayed on the preview display screen.

### <Obtainment of Overlap Portion Information>

An obtainment of overlap portion information will be described. A series of processes regarding the obtainment of the overlap portion information are executed by the overlap portion information obtaining unit 403. The overlap portion information is constructed by overlap portion drawing region information and object types and transparency information of the objects constructing the overlap portion. The overlap portion drawing region information can be obtained by detecting an overlap of the objects and calculating a size and a drawing position of the overlap portion from a size and a drawing position of each object.

Subsequently, an obtainment of the object type of the overlap portion will be described. In the case of the object in the fixed region, since it does not change in accordance with the information of the DB data 315, the object type is obtained from the objects arranged in the template. In the case of the variable region, generally, since the object type is determined when the frame is arranged, the object type is obtained from the arranged frame. If the object type is not determined when the frame is arranged, the object type is obtained from the information of objects which are arranged on the basis of the information of the DB data 315.

The transparency information is information of the presence or absence of the transparency. In the case of the frame of the text, the presence or absence of the transparency is discriminated by checking whether or not the frame arranged at the time of forming the VDP document has the background color. The presence or absence of the transparency of the image is discriminated by checking whether or not the object has an alpha value (also called an alpha channel).

### <Softmask Setting Display Screen>

FIG. 9A is a diagram of an example of a softmask setting display screen 90. Reference numeral 90 denotes a window for performing a softmask setting. A softmask setting instruction from the user which is executed on the softmask setting display screen 90 is processed by the softmask setting unit 404 in accordance with an instruction from the softmask setting button 806 of the user received by the UI unit 401. Reference numeral 901 denotes a softmask setting method selecting radio button for selecting a setting method of the softmask; 904 an object selection pulldown for designating a softmask applying target object; 905 a softmask type selection pulldown for selecting a type of softmask; 907 a priority selection pulldown for selecting an item of a priority of a recommended softmask setting; and 908 an OK button. A result set by the softmask setting display screen is temporarily stored into the HDD 205. When the input controller 202 controls the input from the pointing device such as keyboard, mouse, or the like, each of 901, 904, 905, 907, and 908 executes the selecting operation.

As a softmask setting method, the softmask setting display screen 90 has a softmask details setting 902 and a recommended softmask setting 906. The softmask details setting 902 receives a selection, from the user, about to which one of the foreground and background objects which type of softmask is applied every combination of the overlapping manners of the objects and obtains the softmask setting result. The setting result of the softmask which is set by the softmask setting display screen is called “softmask setting information” hereinbelow. When the UI unit 401 receives a selection of the OK button 908 on the softmask setting display screen from the user, the softmask setting information can be stored into the HDD 205. Stored softmask setting information 100 can be reused for another VDP document. The reuse of the softmask setting information 100 will be described hereinafter.

The recommended softmask setting 906 receives an appearance priority from the user and automatically sets the softmask suitable for the combination of the overlapping manners of the respective objects on the basis of the priority. The appearance priority denotes, for example, a priority allocation based on the object type such as “a priority is given to an appearance of the image than the text”, a priority allocation according to a difference of the fixed region and the variable region such as “a priority is given to an appearance of the object in the variable region than the fixed region”, or the like. In this instance, as an appearance priority, it is assumed that “text priority”, “image priority”, “fixed region priority”, and “variable region priority” can be selected. A case of “text priority” will be described as an example. For instance, for the combination information of the overlapping manners of the objects showing “image+text (transparent)”, the mask of the predetermined value of the high transparency is set to the background image in such a manner that the text can be desirably seen. For the combination information of the overlapping manners of the objects showing “text+image (opaque)”, the mask of the predetermined value of the high transparency is set to the overlap portion of the foreground image in such a manner that the background text can be desirably seen. The softmask setting information associated with the appearance priority has been stored in the HDD 205. When the selection of the priority is received from the user, the softmask setting information associated with the selected appearance priority is called.

### <Softmask Setting Information>

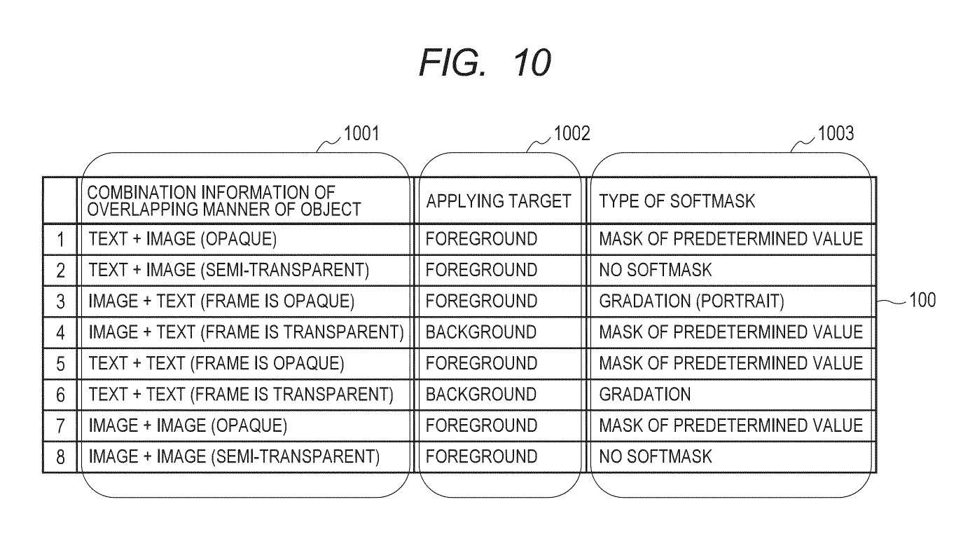

FIG. 10 is a diagram of an example of the softmask setting information 100. Reference numeral 1001 denotes combination information of overlapping manners of objects; 1002 an object as a softmask applying target; and 1003 a type of softmask. The softmask setting information allows the softmask applying target object 1002 and the softmask type 1003 to be associated with the combination information 1001 of the overlapping manners of the objects.

### <Whole Flowchart>

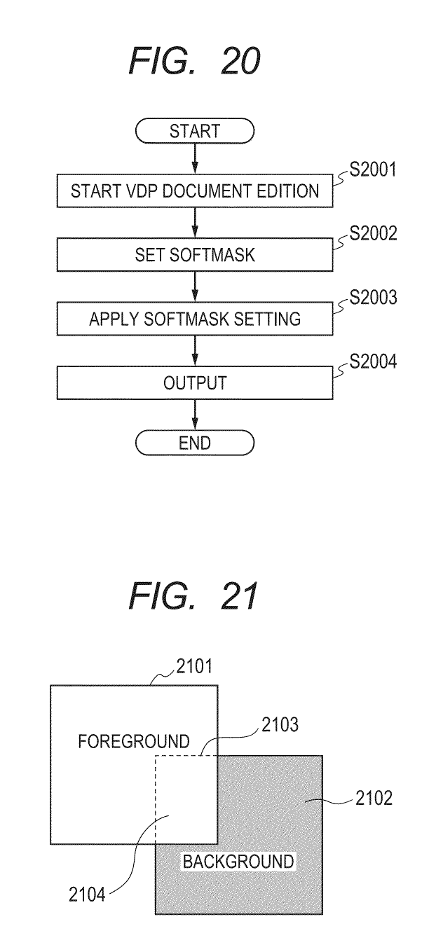

FIG. 20 is a flowchart for describing a flow from a creation of a VDP document to an output of the VDP data according to the information processing apparatus. First, in step S2001, a start of creation of the VDP document is received. Subsequently, in step S2002, the softmask setting is received. Subsequently, in step S2003, the application of the softmask is received. Finally, in step S2004, the formed VDP document is output as VDP data. The softmask setting in step S2002 and the softmask application in step S2003 will be described hereinafter.

### <Softmask Setting Flow>

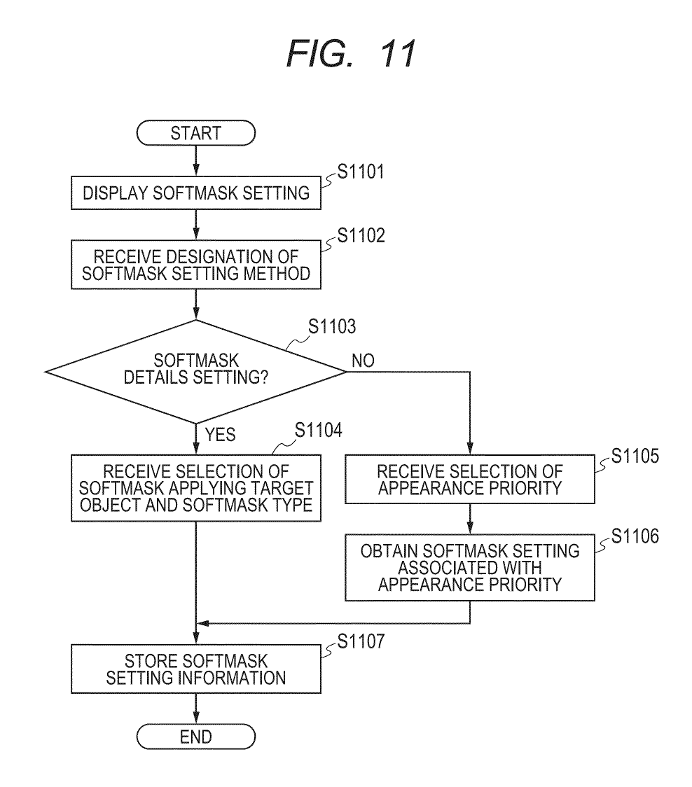

A flow for the softmask setting in step S2002 in FIG. 20 will be described. FIG. 11 is a flowchart for describing the flow for the softmask setting. The softmask setting flow will be described by using FIGS. 8A to 9B. First, in step S1101, when the UI unit 401 receives the selection of the softmask setting button 806 on the template editing display screen 80, the softmask setting display screen 90 in FIGS. 9A and 9B is displayed. At this time, as an initial display of the softmask details setting 902, default values of the softmask applying target object 904 and the softmask type 905 according to combination information 903 of overlapping manners of objects are displayed. It is assumed that the default values are such softmask setting information that both of the background object and the foreground object can be uniformly seen and do not become unnatural. For example, in the case of “image+image (opaque)”, the softmask is set so as to apply the gradation mask to the overlap portion of the foreground image in such a manner that both of the background object and the foreground object are visible and do not become unnatural. Subsequently, in step S1102, when the UI unit 401 receives the selection of the radio button 901, the softmask setting method is designated. Subsequently, if the setting method is the softmask details setting in step S1103, the selection of the softmask applying target object 904 and the softmask type 905 are received for the combination information 903 of the overlapping manners of respective objects in step S1104. On the other hand, if the setting method is the recommended softmask setting in step S1103, the selection of the appearance priority is received by the pulldown 907 in step S1105. The softmask setting information associated with the appearance priority is obtained from the HDD 205 in step S1106. Finally, in step S1107, the softmask setting information in step S1104 or S1106 is stored in step S1107, and the softmask setting is finished.

The case where the setting of the softmask by the softmask setting display screen 90 is applied to the whole VDP document has been described above. In the case of applying the softmask to an individual frame or between the objects, after a selection of the frame or object is received, the softmask is set by the softmask setting display screen to a combination of the object types of the applying target object. Such a process is called “softmask individual setting”.

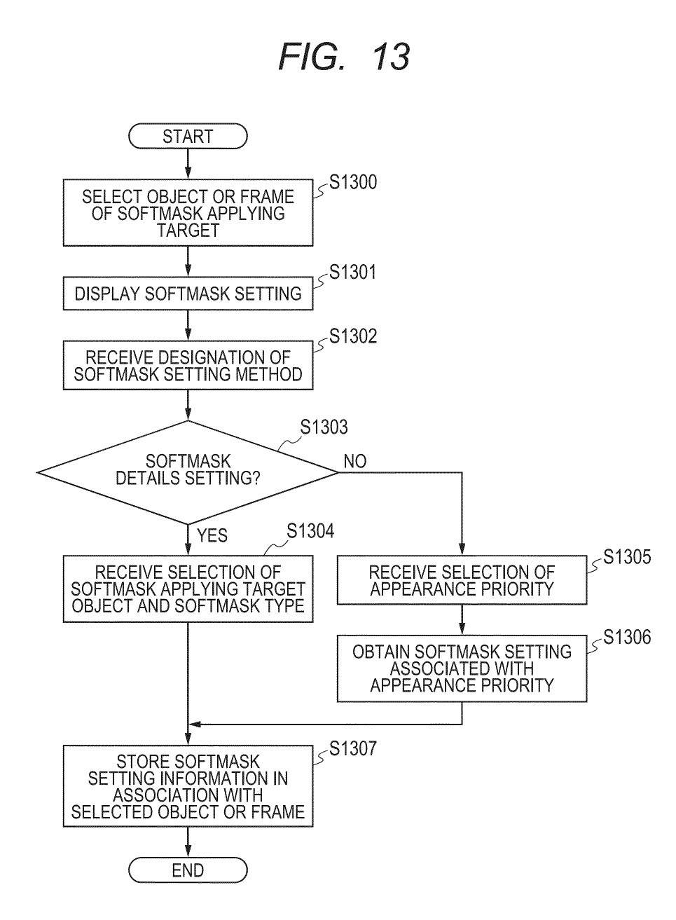

FIG. 13 is a flowchart for describing a flow for the softmask individual setting. The softmask individual setting will be described by using FIGS. 8A, 8B and 9B. First, in step 1300, a selection of the frames 803 and 804 in FIGS. 8A and 8B is received from the user. Subsequently, in step 1301, the selection of the softmask setting button 806 is received from the user and the softmask setting display screen is displayed. FIG. 9B is a diagram of an example of a softmask setting display screen in the softmask individual setting. FIG. 9B is the softmask setting display screen at the time when the selection of the softmask setting button 806 is received after the UI unit 401 received the selection of the frames 803 and 804. Reference numeral 911 denotes a region for performing the softmask details setting and 912 indicates combination information of overlapping manners of objects. At this time, if it has already been known that the object types of the variable regions 803 and 804 are the text and the image at the time of frame selection, in the combination information 912 of the overlapping manners of the objects, a combination in which the type of softmask cannot be set is not displayed. Processes in steps S1302 to S1306 are substantially the same as those in steps S1102 to S1106 in FIG. 11. Finally, in step S1307, the softmask setting information is stored in the HDD 205 in association with the frame in which the selection is received.

Although the variable regions are used in the softmask individual setting in the above description, even in the case where one of them is the fixed region, the same processes are executed. In the case of the fixed regions, the objects are selected instead of the frames.

### <Softmask Applying Flow>

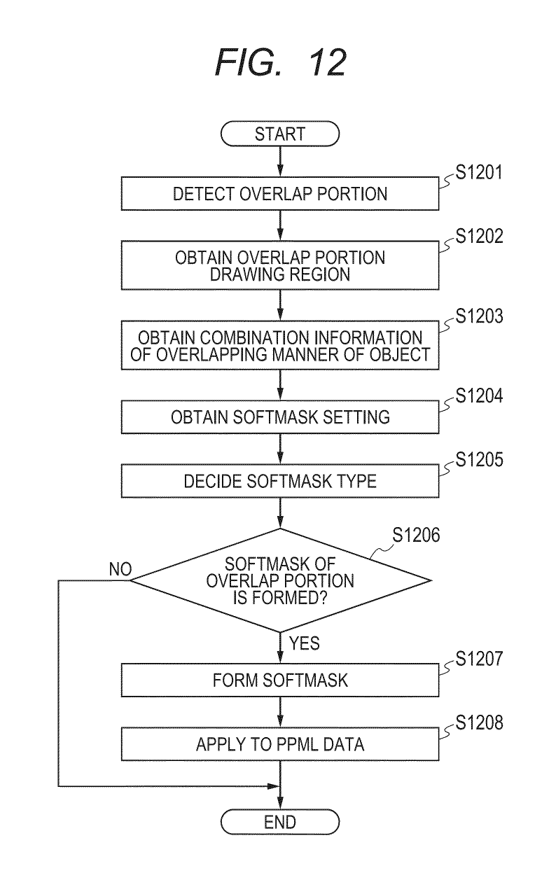

Subsequently, a flow for an application of a softmask to the overlap portion and a PPML output in step S2003 will be described. FIG. 12 is a flowchart for describing the softmask application to the overlap portion. First, in step S1201, when objects are arranged in a document template which is being edited by the VDP application on the basis of the information of the DB data 315, a portion where the objects overlap partially with each other is detected by the overlap portion information obtaining unit 403. When the overlap portion is detected in step S1201, overlap portion drawing region information is obtained by the overlap portion information obtaining unit 403 in step S1202. Information regarding the drawing of the overlap portion such as drawing size, drawing position, and the like of the softmask is obtained from the overlap portion drawing region information. In step S1203, the combination information of the overlapping manners of the objects is obtained. Subsequently, in step S1204, the softmask setting information set in step S2002 in FIG. 20 is obtained from the HDD 205. Subsequently, in step S1205, a type of softmask corresponding to the combination information of the overlapping manners of the objects is decided on the basis of the obtained softmask setting information. Subsequently, in step S1206, whether or not the decided softmask type is “no softmask” is discriminated. If it is determined in step S1206 that the softmask type is “no softmask”, since there is no need to form the softmask, the processing routine is finished as it is. If it is determined in step S1206 that the softmask is formed, in step S1207, the softmask is formed by the bitmap of the gray scale from the drawing region information and the softmask type.

Finally, in step S1208, a description for applying the object of the formed softmask to the softmask applying target object is added to the PPML data.

### <Description of Softmask>

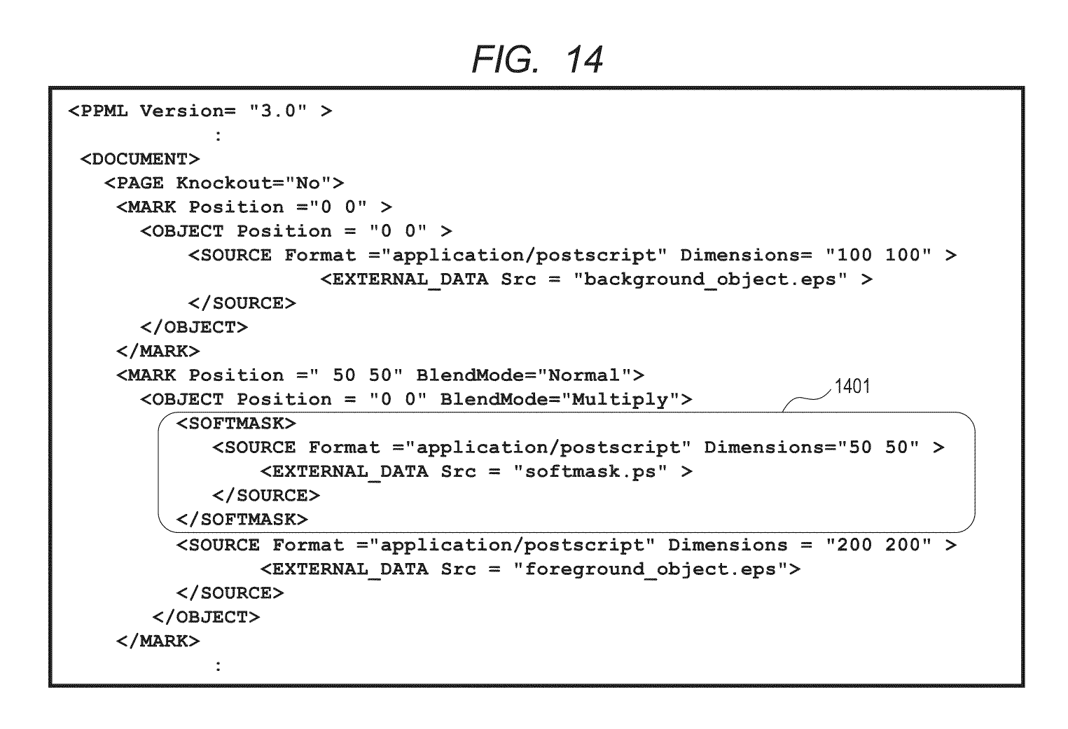

FIG. 14 is a diagram of an example in which the description of the softmask application is added to the PPML data. FIG. 14 is a description of Version3.0 of PPML and the softmask can be defined by a SOFTMASK element. The PPML data has a layer structure. In the layer structure, a PPML element is set to the highest layer and a PAGE element defines a logical page. A MARK element designates a layout of the objects in the page. An OBJECT element defines an object which is drawn in the page. The MARK and OBJECT elements can have the SOFTMASK element as a child element. The SOFTMASK element defines a softmask as an object for partially making other objects transparent. The SOFTMASK element has a SOURCE element as a child element. The SOURCE element defines an object which is converted into a softmask. Reference numeral 1401 in FIG. 14 denotes a description of a softmask definition using the SOFTMASK element. A bitmap “softmask” of the softmask is defined as a softmask by the SOFTMASK element. The PPML data in FIG. 14 defines a layout of a background object “background object” and a foreground object “foreground_object” and those two objects have an overlap portion. The two objects are images and the foreground object “foreground_object” is a softmask applying target object. At this time, when the description of the softmask definition is added to a position before the foreground object “foreground_object”, the softmask is applied to the overlap portion of the foreground object “foreground_object”.

<Softmask Application after PPML Formation>

The method whereby the softmask is set by the VDP application at the time of the template edition and the softmask is applied when the PPML data is output has been described above. A method whereby the setting and application of the softmask are executed after the PPML data is formed instead of the timing when the PPML data is output will be described hereinbelow.

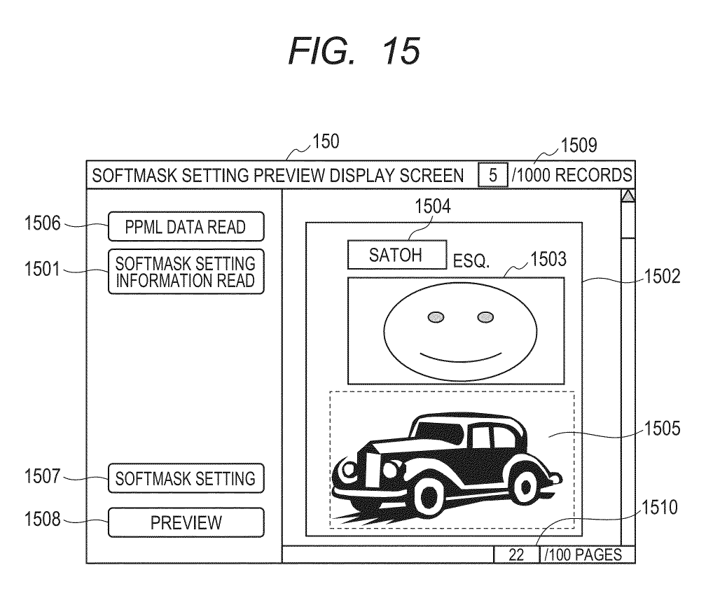

FIG. 15 is a softmask setting preview display screen 150 in which the formed PPML data is read and a finish image of every record is displayed to the user. Reference numeral 1501 in FIG. 15 denotes a softmask setting information read button for reading the softmask setting information described in FIG. 10; 1506 a PPML data read button for reading the PPML data from the outside; 1502 a preview result display region of the read PPML data; 1503 and 1504 variable regions; 1505 a fixed region; 1509 a record designation box for designating a number of the record which is previewed; 1510 a page designation box for designating a number of the page as a preview target; 1507 a softmask setting button for displaying the softmask setting display screen; and 1508 a preview button. When the UI unit 401 receives a selection of the preview button 1508, a preview result of the VDP document to which a change to the PPML data has been reflected is displayed to the preview result display region 1502. In FIG. 15, the 22nd page of the 5th record of the PPML data is displayed.

A softmask setting to the formed PPML data will be described by using FIG. 15. FIG. 19 is a flowchart for describing a flow for the softmask setting to the formed PPML data. First, in step S1901, the UI unit 401 receives the selection of the PPML data by selecting the PPML data read button 1506 and reads the PPML data. In step S1902, a print image of the read PPML data is displayed to the preview result display screen 1502. Subsequently, in step S1903, if the softmask setting information already exists in the HDD 205 and is used again, the UI unit 401 receives a selection of the softmask setting information read button 1501 from the user and obtains the softmask setting information. Subsequently, if the softmask setting information is not obtained in step S1904, in step S1905, the UI unit 401 receives a selection of the softmask setting button 1507 from the user, displays the softmask setting display screen, and sets the softmask. If the softmask setting information is not obtained, default values are displayed. If the softmask setting information has already been obtained in step S1904, the obtained softmask setting information is displayed on the softmask setting display screen in step S1906. The softmask setting information is edited in step S1907. It is assumed that the softmask setting display screen is the same as the display screen in FIGS. 9A and 9B. Finally, in step S1908, the UI unit 401 receives a selection of the preview button 1508 from the user and displays a print image to which the softmask setting result has been reflected to the preview result display screen. In the case of applying the softmask only to the selected frame of the designated page of the designated record, in a manner similar to the softmask individual setting at the time of the template edition, after the selection of the frame is received, the selection of the softmask setting button is received and the softmask is set.

### Second Embodiment

In the first embodiment, the example in which the appearance is corrected for the overlap objects by using the softmask has been described. In the second embodiment, an example in which an exchange of the foreground and the background of the overlap objects is added to the first embodiment will be described. In the second embodiment, substantially the same description as that for the first embodiment is omitted and only different points will be described. Therefore, it should be noted that the first embodiment is also referred to if there is no special description.

### <Exchange of Background and Foreground>

There is a case where if the foreground and the background are exchanged in the overlap portion before the softmask setting, a mask which is applied to the overlap portion is not made complicated more than it is needed and an appearance can be improved. For example, in the case where the softmask is applied to the overlap portion of the image for the combination information 604 of the overlapping manners of the objects, the background text remains rarely visible in dependence on the foreground image, and there is a possibility that a complicated softmask is applied to further improve the appearance. At this time, after the text existing on the background and the foreground image are exchanged, if a process for “image (opaque)+text” is executed, there is a case where the appearance of the text can be improved without applying the complicated softmask more than it is needed. When exchanging the foreground and the background, since transparency information of the background object exerts an influence on the selection of the softmask, the transparency information of the background object is obtained.

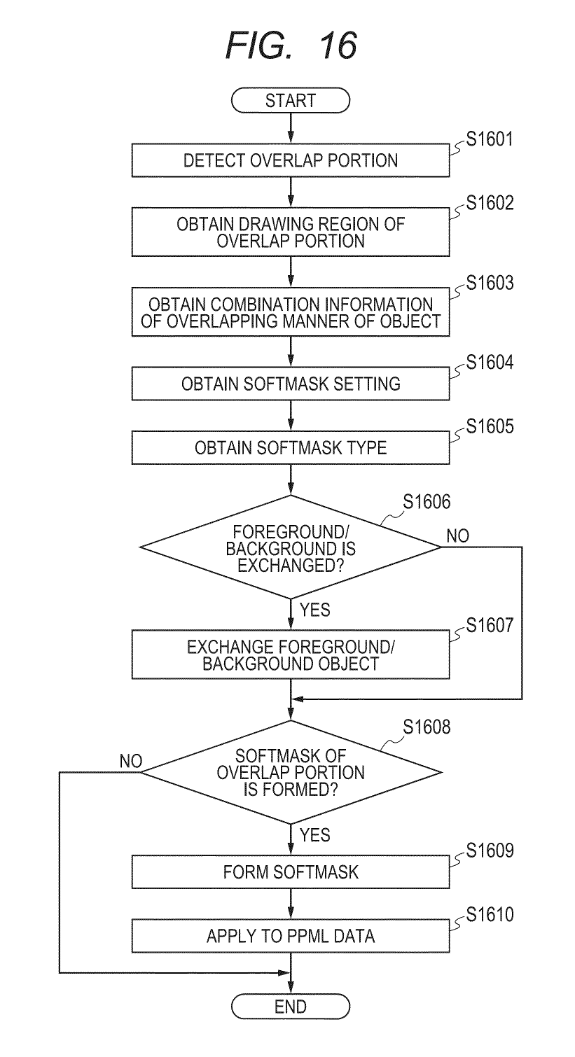

FIG. 16 is a flowchart for describing a flow for a softmask application including an exchange of the foreground and background objects in the overlap portion in the embodiment. Since processes in steps S1601 to S1605 are substantially the same as those in steps S1201 to S1205 in FIG. 12, their description is omitted. If an instruction to exchange the foreground and the background of the objects is obtained in step S1606, drawing order of the objects having the combination information of the overlapping manners of the designated objects is changed in step S1607. After the exchange of the foreground and the background of the objects is performed in step S1607, processes in steps S1608 to S1610 are substantially the same as those in steps S1206 to S1208 in FIG. 12.

### Third Embodiment

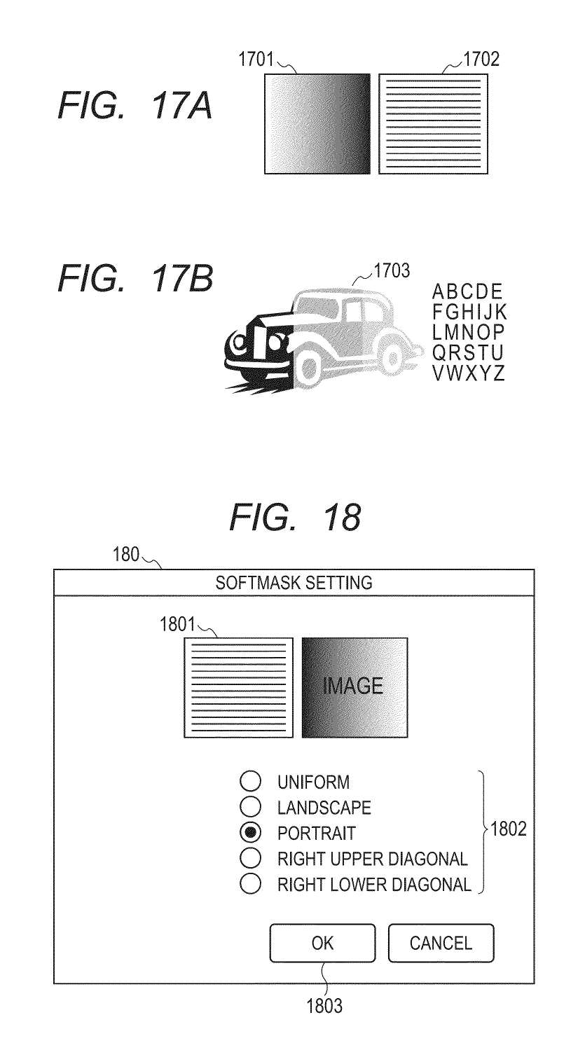

In the first embodiment, the example in which the appearance is corrected by using the softmask for the overlap objects has been described. In the third embodiment, an example in which a softmask application in the case where the objects do not over is added to the first embodiment will be described. In the third embodiment, substantially the same description as that for the first embodiment is omitted and only different points will be described. Therefore, it should be noted that the first embodiment is also referred to if there is no special description. The objects which are in contact with each other in the landscape or portrait direction as illustrated in FIGS. 17A and 17B without overlapping or the objects existing within a distance which is set by the user on a distance setting operating unit (not shown) are “approximate” objects.

### <Softmask Application in Non-Overlap Case>

When the image is approximate to the text, there is a case where characters of the text near the image are difficult to view. Even in the case where they do not overlap as mentioned above, for the image which is approximate to the text, by applying the softmask to the image so that an opaque degree of a portion near the text decreases, the text can be made to be easily seen. For example, when the frame of the text exists around the image, for example, on the right side thereof, such a gradation mask in the portrait direction that an opaque degree of a right portion near the text is small and an opaque degree of a left portion near the text is large is formed as a bitmap and applied to the image. FIGS. 17A and 17B are an example of an image diagram in which the gradation mask is applied to the selected frame. Reference numeral 1701 in (a) denotes a gradation mask and 1702 indicates a text frame. Reference numeral 1703 in (b) denotes an image diagram of a result in which the gradation mask 1701 is applied to an image to which a frame of a text is approximate.

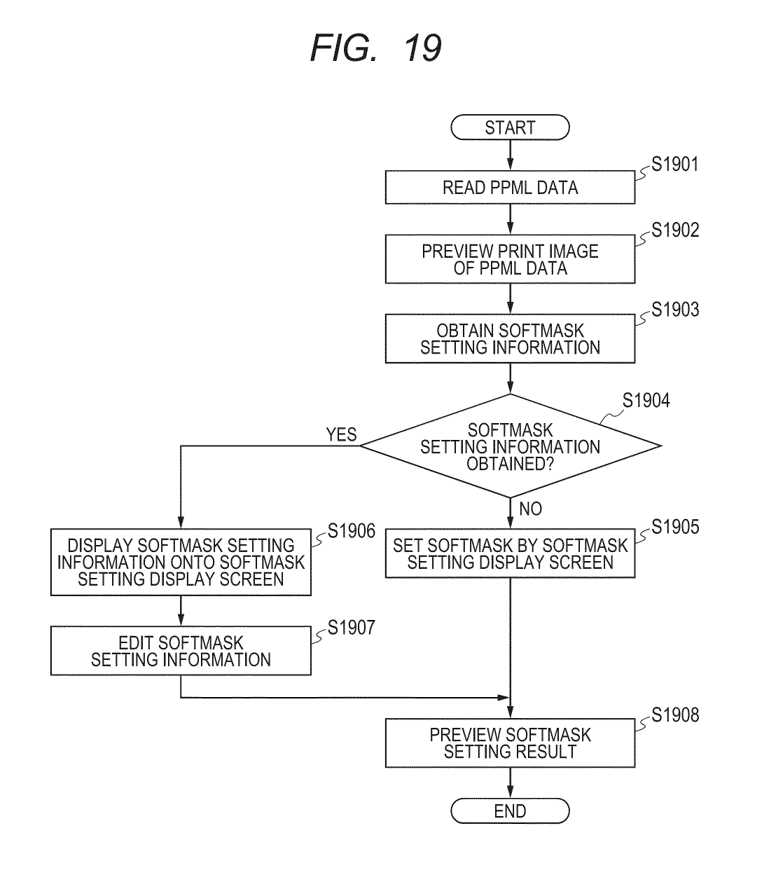

A method of applying the softmask in the case where the frames or objects do not overlap with each other will be described by using FIGS. 8A and 8B. FIG. 18 is a softmask setting display screen 180 which is displayed by receiving the selection of the softmask setting button after a selection of one object is received on the template editing display screen of FIGS. 8A and 8B. It is assumed that one object whose selection is received is an object in the fixed region in which the object type is the image. A softmask applying result 1801 visually expresses an image showing which kind of softmask is applied in a positional relation between the frame of the text and the image. Reference numeral 1802 denotes a radio button for receiving a designation of a mask of a predetermined value or a designation of a direction of the gradation. When the direction such as “portrait”, “landscape”, or the like is designated, the gradation mask is designated in such a direction. When “uniform” is selected, the mask of a predetermined value is designated. By receiving the designation of the radio button 1802, the applying result 1801 in which the designated softmask is applied to the selected image is updated. By receiving a selection of an OK button 1803, the softmask is set to the designated object. By the above setting, if the text exists near the designated object when the PPML data is output, a softmask which is applied to the whole designated object is formed and the description of the softmask is added to the PPML data.

Although the method of applying the softmask to the object in the fixed region has been described above, substantially the same processes are executed to the variable region. In the case of the variable region, a selection of one frame is received.

As mentioned above, the softmask is set every combination of the overlapping manners of the objects and print job data in which the set softmask is applied to the relevant object can be formed.

The optimum softmask can be set on the basis of an appearance priority which the user desires.

The softmask can be set to the whole VDP document, to the individual frame, or between the objects.

The softmask can be set to the print job data when a print job is formed or to the print job data which is output. By applying the softmask to the object in which the text frame exists approximately, a portion to which the object of the text is approximate can be made easy to view.

### Other Embodiments

The invention is also realized by executing the following processes. That is, software (program) for realizing the functions of the embodiments mentioned above is supplied to a system or apparatus through a network or various kinds of storage media and a computer (or a CPU or MPU or the like) of the system or apparatus reads out the program and executes the processes based on the program.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-145385, filed Jun. 30, 2011, which is hereby incorporated by reference herein in its entirety.

1. An information processing apparatus comprising:
softmask setting means for setting a softmask every combination of objects of an overlap portion of the objects; and
softmask applying means for applying the softmask to the overlap portion of the objects in accordance with the setting performed by the softmask setting means.

2. An information processing apparatus according to claim 1, wherein the setting performed by the softmask setting means includes a setting of types of the objects constructing the overlap portion.

3. An information processing apparatus according to claim 1, wherein the setting performed by the softmask setting means includes a setting of the presence or absence of transparency of each object constructing the overlap portion.

4. An information processing apparatus according to claim 1, wherein the setting performed by the softmask setting means includes a setting of the presence or absence of a background color of a text frame in which the objects constructing the overlap portion.

5. An information processing apparatus according to claim 1, wherein the softmask setting means sets the softmask on the basis of an appearance state.

6. An information processing apparatus according to claim 1, wherein the softmask setting means sets the softmask to a whole document.

7. An information processing apparatus according to claim 1, wherein the softmask setting means sets the individual softmask between two or more frames.

8. An information processing apparatus according to claim 1, wherein the softmask setting means sets the softmask to a frame or object around which text frames which are approximate although they do not overlap exist.

9. An information processing apparatus according to claim 1, wherein the setting performed by the softmask setting means is stored.

10. An information processing apparatus according to claim 1, wherein the softmask setting means sets the softmask to an overlap portion of at least a text object and an image object.

11. An information processing method comprising:
a softmask setting step of setting a softmask every combination of objects of an overlap portion of the objects; and
a softmask applying step of applying the softmask to the overlap portion of the objects in accordance with the setting performed in the softmask setting step.

12. An information processing method according to claim 11, wherein the setting performed in the softmask setting step includes a setting of types of the objects constructing the overlap portion.

13. An information processing method according to claim 11, wherein the setting performed in the softmask setting means includes a setting of the presence or absence of transparency of each object constructing the overlap portion.

14. An information processing apparatus according to claim 11, wherein the setting performed by the softmask setting step includes a setting of the presence or absence of a background color of a text frame in which the objects constructing the overlap portion.

15. An information processing apparatus according to claim 11, wherein the softmask setting step sets the softmask on the basis of an appearance state.

16. An information processing apparatus according to claim 11, wherein the softmask setting step sets the softmask to a whole document.

17. An information processing apparatus according to claim 11, wherein the softmask setting step sets the individual softmask between two or more frames.

18. An information processing apparatus according to claim 11, wherein the softmask setting step sets the softmask to a frame or object around which text frames which are approximate although they do not overlap exist.

19. An information processing apparatus according to claim 11, wherein the setting performed by the softmask setting step is stored.

20. A computer program comprising processor implementable steps for performing a method according to claim 11.
